(19) United States
(12) Patent Application Publication
(10) Pub. No.: US 2008/0300814 A1
(43) Pub. Date: Dec. 4, 2008

(54) Interoperability digital exchange capture and replay product

(76) Inventors: Richard VaNeile Drummond, II, Fort Worth, TX (US); Jo Elizabeth Morrow, Austin, TX (US)

Correspondence Address: JACKSON WALKER LLP, 901 MAIN STREET, SUITE 6000, DALLAS, TX, 75202-3797, US

(21) Appl. No.: 12/082,765

(22) Filed: Apr. 14, 2008

Related U.S. Application Data
(60) Provisional application No. 60/923,483, filed on Apr. 13, 2007.

(51) Int. Cl. G06F 19/00

(52) U.S. Cl. 702/108

(57) ABSTRACT

An interoperability replay system and method allowing products that were not included in an interoperability test event to participate as if they were part of it in the past. On method comprises replaying to them the choreographies of the digital exchanges between the products in the previous interoperability test event. Choreographies are the digital interchanges between Systems-Under-Test (SUT) and include, but not limited to, the business process protocols, their data and logic exchanges supported by all subsidiary (underlying) layers of the protocol stack including digital security. Choreography may be between only two SUTs or among several SUTs assuming different roles and coordinated amongst each other to complete the business process. The business process may be composed of several transactions. This invention includes the collection and replay of these choreographies and all subsidiary protocol layer digital exchanges among the SUTs during an interoperability test event.

### FIELD OF THE INVENTION

The present invention relates to interoperability testing services for products conforming to a standard or set of standards.

### BACKGROUND OF THE INVENTION

During an interoperability test event—which is a defined period of testing time—different systems come together and exchange in a pair-, 3-, 4-, n-wise manner, with all other systems, choreography and supporting subsidiary protocol digital packets in conformance to a standard, or business message flow that may involve several different systems playing different roles in the exchange. In order to fully test for interoperability, these systems must exchange choreography and supporting subsidiary protocol digital packets with every other system participating in an interoperability testing event playing all the respective roles they have chosen to support from the standard under test.

### SUMMARY OF INVENTION

The present invention achieves technical advantages as a system and method of capturing choreography and supporting subsidiary protocol digital exchanges, and re-utilizes them for companies that want to test after the test event without having to re-gather all participants for another test event. This enables the new SUT to be more prepared for the next test event and encourages a fuller interoperability with the group of all products conforming to a standard or set of standards.

### BRIEF DESCRIPTION OF THE DRAWINGS

FIG. 1 shows a block diagram of one embodiment of the present invention;

FIG. 2 shows a diagram of an example from SAML;

FIG. 3 shows another diagram of an example from SAML; and

FIG. 4 shows an example where applications take on different roles.

### DETAILED DESCRIPTION OF THE PRESENT INVENTION

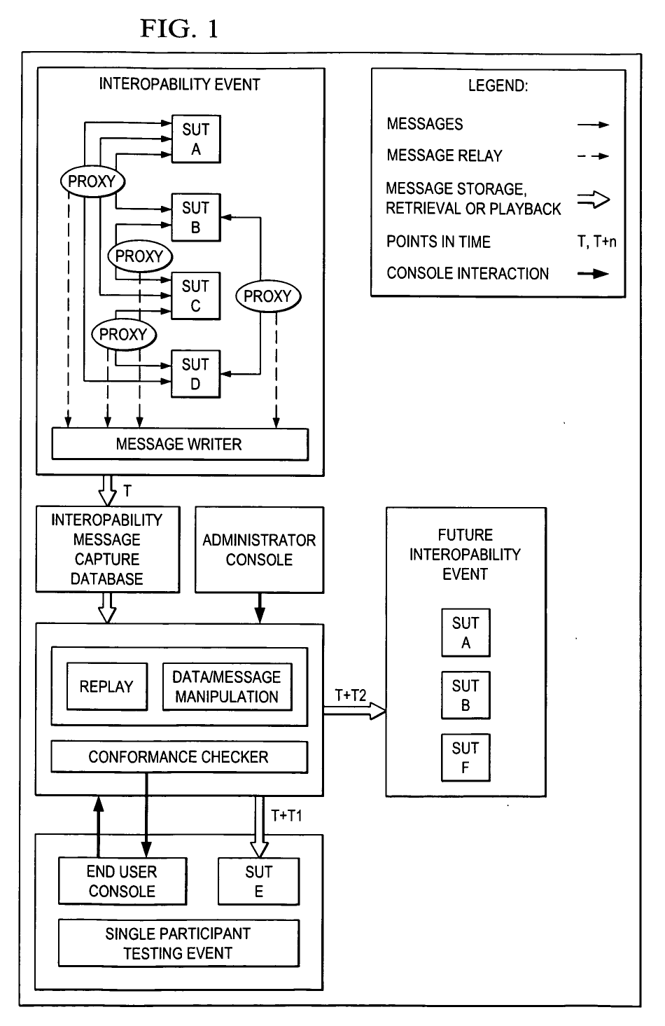

Referring to FIG. 1, aspect's of the present invention, referred to hereafter as an interoperability replay product, provides the ability, to a very great extent, to recreate a previous interoperability test event environment as needed to test a product. It accomplishes this by replaying the choreographies and supporting lower protocol layer digital exchanges captured and recorded during the execution of a previous interoperability event to the product. Advantageously, these captured choreographies and supporting lower protocol digital exchanges are adjusted in a manner that retains the interoperability and conformance aspects of the previous interoperability test event, yet allows a new untested product to participate in the captured choreography. Interoperability tests discover product issues, over and above conformance, that must be worked around to maintain interoperability, and hence, interoperability replay captures these issues besides just capturing working interoperable choreographies.

The captured choreography and supporting subsidiary protocol digital exchanges from all the many products of a previous interoperability test event can then be used in a future point in time (with appropriate modifications), to replay them to the product, and thus allow the product to be validated against previously tested products to check for interoperability and interoperability's subcomponent conformance. This advantageously allows products that did not participate in interoperability test event to verify to a meaningful degree that they will interoperate to a high degree with products from a previous test event.

This application provide the architecture on how this collection of choreographies and the subsidiary (underlying) protocol layers digital exchanges are modified and replayed. The goal is to collect the choreography and supporting subsidiary protocol digital exchanges during full-matrix testing (all role interactions among all test participants).

The design is not specific to any technical standard or messages, data, digital certificates, choreographies, or exchange system, but will work with any standard or digital exchange system, either peer to peer, master slave, or several systems interacting as different roles to complete specified functionality. Different behavior conditions can also be programmed into the replay system, so that testing for various types of errors, such as no response, or timing errors can checked.

A system that participates in an interoperability testing event is referred to as a “system under test”, or SUT. The set of all SUTs in an interoperability test event are referred to as SUT's. Many SUT's can participate, and there is no upper limit. At minimum, two have been required to carry out some form of interoperability testing. However, there is a need for even a single SUT to re-test, or test for a first time, for some form of interoperability even if the other SUT's are not physically available to participate. On aspect of the present invention, referred as the replay product, supports this by allowing a single, new, or returning new SUT's to receive captured messages/data/digital certificates/choreographies/etc exchanges, thus allowing them to test for interoperability in a simulated manner.

The replay product does not interfere with the operation of the SUTs, the choreography and supporting subsidiary protocol digital it receives or sends during the collection process. The use of a “proxy” is introduced for the capturing of message to and from the SUT's, or the SUT's can be instrumented to provide the capture of the choreography and supporting subsidiary product digital exchanges.

The replay product has five sub-systems:

1. Capture

2. Conformance Checking

3. Modification of Captured Data

4. Replay

5. End-User Interface

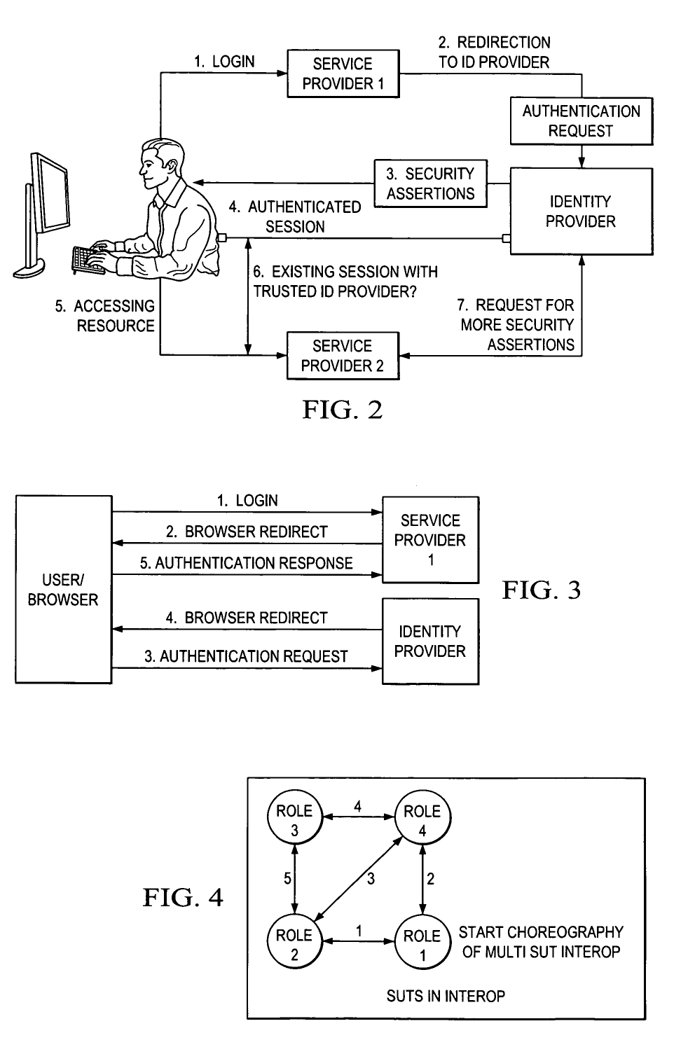

Referring to FIGS. 2 and 3, the following sections describe each of these sub-systems.

The replay product captures the choreography, the sub-choreographies, the data moving to support the choreography (certificates, payloads, messages, etc.), and maintains it in a repository to be re-targeted for later re-use in future interoperability events. FIG. 4 shows an example where applications take on different roles.

### Capture Sub-System

### Digital Exchanges

The messages exchanged between individual SUT's conform to a given standard, like AS2, or AS3, or GDSN, or ebXML, web Services, but is not limited to these. The content exchanged in the messages sometimes also conforms to a standard. For instance, GDSN and ebXML have well defined payload structures defined in XML. The message flow is based on choreography. All of these—messages, choreographies, data, certificates, etc,—are captured for later replay. These are referred to as “digital exchanges”.

Furthermore, the digital exchanges themselves may be encrypted, compressed, or signed. The replay product captures and stores these payloads/messages/data/digital certificates/choreographies/etc (via the recording mechanism), and analyzes them at a later time for conformance validity. In addition, the captured payloads/messages/data/digital certificates/choreographies/etc can also be “replayed” so as to mimic the sending characteristics of an SUT to other SUT's participating in future interoperability events or other testing events.

Key to this is that the replay product has knowledge of the standards, including message exchange protocols as well as content. Along with this, the replay product has available public and private certificates in order to decrypt the payloads and validate signatures and content.

Participants must be aware that the sharing of certificates will be required.

### Capture Mechanism

A capture mechanism allows for quick and easy use of the replay product, and speeds up its adoption. Giving participants the option to instrument or not instrument their products in order to implement payload/message/choreography/etc. capturing is important as it allows their products flexibility in how they provide the capture mechanism.

### Digital Exchange Writer

The message writer interacts with the choreography/payload/message/certificate storage database, and writes every digital exchange, in its exact form it is being exchanged in. No tampering or altering of the digital exchange occurs.

### Digital Exchange Database

The digital exchange database maintains a historical account of all exchanges including choreographies, certificates, messages, payloads, etc.

### Digital Exchange Modification Sub-System

In order to re-use, that is replay the choreography and supporting subsidiary protocol digital exchanges that were captured, the replay mechanism can easily look up or query exchanges that have occurred in the past, and re-target them to new participants, potentially modifying the digital exchanges to the recipient so that specific information or content fields are targeted at the new receiving SUT. In no way is the original message altered, however, a new database entry is generated for the new digital exchange created for a replay instance.

### Conformance Checking Sub-System

Captured digital exchanges can be checked for conformance to the standard(s) under test. Reporting to the end-user is provided via the User Interface.

### Replay Sub-System

The ability for a participant to, on-demand, request choreography and supporting subsidiary protocol digital exchange replay to simulate interoperability scenarios with non-physically present SUT's is described next.

### Replay Mechanism

The replay mechanism interacts with the end-user console, the choreography and supporting subsidiary protocol digital exchange database, and new and returning SUT's of current or future interoperability events. Its responsibility is to make sure the message retrieved from the choreography and supporting subsidiary protocol digital exchange database is properly formatted for the targeted SUT, and to capture responses and record them. This is known as a replay scenario.

Replay scenarios may be scheduled by end-users, and results of the replay scenarios are reported to the end-user via the end-user console.

### “Interoperability” Replay Actors

Interoperability events occur during the course of time, usually with a different set of participants, and mostly but not all returning SUT's. The ability of future interoperability events to reveal conformance and interoperability issues can be greatly enhanced if digital exchanges from previous interoperability events could be replayed during future interoperability events as new and returning SUT's could have a wider testing arena.

### New SUT

A new SUT is a system under test which has not participated in earlier interoperability events, or for which there is no history in the digital exchange database.

### Returning SUT

A returning SUT is a system under test which has participated in earlier interoperability events, and for which there is history in the digital exchange database.

### New Participants

New participants may wish to test with the replay product before entering an interoperability testing event, ensuring that their product has interacted in a “receiving” or “sending” mode with SUT's that have historically participating in testing events. This guarantees the broadest possible state “readiness” for participating in future interoperability events, thus reducing the future work-load of the new participants.

Each choreography and supporting subsidiary protocol exchange may be traded between new participants in a “sending or receiving” mode with SUTs of previous historical testing events. This covers all business level interactions between new participants playing both roles of past interoperability test events.

It also allows new participants to test their new SUT for conformance and interoperability issues which have been captured in the digital exchange database.

### Returning Participants

Returning Participants may wish to re-test all receiving and/or sending digital exchange scenarios from historical test events to ensure that their product meets QA standards before going to market. During the course of a products life-cycle, real-time interoperability events may not be scheduled by DGI, but participants may still plan a release of their product.

By testing with the replay product, these participants may test with in a simulated interoperability event thus allowing them to check for conformance to a standard and interoperability between them and other products before releasing their product.

### Non-Returning Participants

Non-returning participants are participants that have participated at least once in an interoperability testing event, but have not returned for additional testing. Their choreography and supporting subsidiary protocol digital exchanges have been captured in the choreography and supporting subsidiary protocol digital exchange database and the choreographies of these participants may be replayed in future interoperability events.

### End-User Interface Sub System

### End-User Console

Participants of future testing events are provided with an “end-user console”, which can be an executable residing locally, or web browser based, that allows them to configure their SUT parameters, and to schedule replay digital exchange scenarios in which they play one role at a time in an n-wise multi-role/multi-SUT choreography. Participants are allowed to select individual or sets of individual SUT's that exist in the choreography and supporting subsidiary protocol digital exchange database, and request they be included in one of the roles in a choreography residing in the choreography and supporting subsidiary protocol digital exchange database.

After execution of the replay test scenario, results of the execution are presented to the end-user via the end-user console.

### Admin Console

The administrator console allows for an end-user, whose role is administration of the replay product, to add new participants, or to remove them. It also allows the administrator to control the visibility of the historical choreography and supporting subsidiary protocol digital exchanges, thus new participants may be restricted to a certain set of SUT's, but not others.

### Continual Testing Over Time at any Time

Testing events occur over time. Each testing event normally has its own unique set of participants. Testing data that occurred in earlier testing events is of interest to participants of future interoperability testing events. The choreography and supporting subsidiary protocol digital exchanges captured at one point of time remain useful and important for testing events at future points of time. The replay product allows for these different points of time to be joined and for choreography and supporting subsidiary protocol digital to be exchanged.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method of providing interoperability testing of products conforming to at least one standard, comprising the steps of:
testing interoperability of at least two said products during a first event;
recording aspects of the first event; and
testing interoperability of a third said product during a second event, occurring after the first event, based on said recorded aspects.
